(19) United States
(12) Patent Application Publication
(10) Pub. No.: US 2003/0066602 A1
(43) Pub. Date: Apr. 10, 2003

(54) Method and apparatus for processing a multilayer plastic film with a heat-sealable surface layer

(75) Inventors: Andreas Rutz, Lindau (DE); Adolf Mueller, Achberg (DE)

Correspondence Address: FASSE PATENT ATTORNEYS, P.A., P.O. BOX 726, HAMPDEN, ME, 04444-0726, US

(73) Assignee: Lindauer DORNIER Gesellschaft mbH, Lindau (DE)

(21) Appl. No.: 10/267,070

(22) Filed: Oct. 7, 2002

(30) Foreign Application Priority Data
Oct. 6, 2001 (DE) 101 49 371.1

(51) Int. Cl. B32B 31/20; B32B 31/00

(52) U.S. Cl. 156/308.2; 156/498; 156/499

(57) ABSTRACT

A multilayer plastic film having a heat-sealable surface layer is initially provided at a process temperature above a heat-sealing temperature of the surface layer. To prevent the surface layer from adhering onto a deflection roller, this layer must be cooled below the heat-sealing temperature. A cooling arrangement is positioned directly upstream from the deflection roller and blows cold air onto the heat-sealable surface layer. Thereby, the surface layer is rapidly cooled below the heat-sealing temperature, while most of the multilayer film is not substantially cooled and remains close to the process temperature. A counter-heater may heat the opposite surface of the plastic film as the cooling arrangement cools the heat-sealable surface layer.

### PRIORITY CLAIM

This application is based on and claims the priority under 35 U.S.C. §119 of German Patent Application 101 49 371.1, filed on Oct. 6, 2001, the entire disclosure of which is incorporated herein by reference.

### FIELD OF THE INVENTION

The invention relates to a method and an apparatus for processing a multilayer plastic film having a relatively low temperature heat-sealable or heat-bondable surface layer, whereby the processing is especially carried out at a process temperature higher than the melting or sealing temperature of the heat-sealable surface layer.

### BACKGROUND INFORMATION

It is generally known to use multilayer laminated plastic films in a variety of applications. Such multilayer plastic films often include at least one surface layer of a heat-sealable or heat-bondable plastic material, which becomes tacky or melts at a relatively low temperature. By heating the heat-sealable surface layer to a temperature at or above its melting or heat-sealing temperature, this surface layer can be adhered and sealed onto other plastic materials or layers, or onto other portions of the multilayer plastic film, for example to achieve a sealed plastic film packaging.

In many applications, the successful processing of the multilayer plastic film depends on good transport or running characteristics and a high processing speed of the multilayer plastic film, in order to achieve a satisfactory and economical processing and finished product. A significant factor affecting the transport characteristics and the processing speed of the multilayer plastic film is the thermal sealability or bonding ability of the film.

In various packaging machines, such a multilayer plastic film is laid or wrapped around the product that is to be packaged, and then the overlapping areas of the film or films must be adhered and sealed with each other. This is generally achieved by providing a heat-sealable surface layer as mentioned above, and by heating this layer to at least its heat-sealing temperature, so that it adhesively bonds together the overlapping film portions. The heat-sealable surface layer is typically provided by co-extruding a heat-sealable layer with one or more other layers forming a base film structure. During the co-extrusion, the films must be heated, whereby the heat-sealable surface layer will adhere onto the underlying layer once it reaches the required sealing temperature.

It is generally known that polymer films are typically rather poor thermal conductors. Therefore, it takes a certain amount of time for heating such polymer films, and especially multilayer polymer films, to the required heat sealing temperature, because of the time it takes for the heat to penetrate through the layers of the polymer film. This film heating time typically represents a substantial portion of the total time required for carrying out a film packaging process as described above, and the heating step is typically the process speed limiting step. In other words, the time required for heating the polymer film to the heat sealing temperature is typically the slowest step in the process, and therefore the process cannot proceed any more quickly than allowed by the heating time.

By reducing the temperature at which the heat sealing ability is initiated, and by correspondingly modifying the co-extruded layers of the multilayer plastic film, the time required by the heating and the heat-sealing process, as a portion of the total processing time, can be reduced. Thereby, the achievable processing speed is increased. However, a reduced heat-sealing temperature causes other problems. For example, the heat-sealable surface layer, which becomes melted or tacky at a relatively low temperature, may undesirably become adhered onto components of the processing equipment, such as guide, support, transport and deflection rollers. Namely, various heating and cooling processes are required in the production and processing of such heat-sealable films. This is typically achieved either by direct contact heating or cooling of the film passing over rollers, or by blowing correspondingly tempered air onto the film. Additionally, the film must be guided and transported through the processing machine, e.g. over guide rollers and deflection rollers as mentioned above.

Throughout this process, typical processing temperatures lie in the range from 80° C. to 220° C. The presently known multilayer plastic films with a heat-sealable surface layer are typically activated to become tacky or heat-sealable at temperatures in a range from 100° C. to 140° C. The trend, however, is toward using ever lower heat-sealing activation temperatures. For example, polymers are being tested for use in a heat-sealable layer, with a heat-sealing temperature of 70° C. to 80° C. The substantial temperature difference between the processing temperatures and the heat-sealing temperatures lead to problems in the processing machine, and especially in connection with the heating and deflection rollers. Particularly, any roller that contacts the heat-sealable surface layer of the plastic film and that has a surface temperature at or above the heat-sealing temperature of the film, will lead to a heat-sealing adhesion of the heat-sealable layer onto the surface of the roller, which thereby destroys the film or at least the heat-sealable layer thereof. Moreover, this leads to operational problems and interruptions, due to the contamination of the rollers, which leads to a stoppage of the machine.

It is possible to heat the film as well as its heat-sealable layer to above the heat-sealing temperature by means of a contactless heating. Moreover, even if a deflection roller is cooled to below the heat-sealing temperature, a deflection of the heated film over such a cooled roller is nonetheless critical, because the hot heat-sealable layer will still have a temperature that is too high, i.e. a temperature above the heat-sealing temperature, at the time when it first contacts the cooled deflection roller. Thus, the hot tacky heat-sealable surface layer that first contacts the cooled deflection roller can still become adhered onto the roller.

### SUMMARY OF THE INVENTION

In view of the above, it is an object of the invention to provide a method and an apparatus for processing multilayer plastic films having a heat-sealable outer layer, whereby a roller can be used for deflecting, guiding, transporting or supporting the hot film, without damaging the heat-sealable surface layer or damaging the deflection roller, even in connection with such films having a rather low heat-sealing temperature. The invention further aims to avoid or overcome the disadvantages of the prior art, and to achieve additional advantages, as apparent from the present specification. The attainment of these objects, however, is not a required limitation of the claimed invention.

The above objects have been achieved according to the invention in a method of processing a multilayer plastic film having a heat-sealable surface layer, including steps of heating the film to a process temperature so that the heat-sealable layer is at or above the heat-sealing temperature, then cooling the heat-sealable surface layer of the film to below the heat-sealing temperature without substantially cooling the other layers of the multilayer film below the process temperature. Particularly, at least one other layer of the multilayer film remains at a temperature above the heat-sealing temperature and preferably within 10° C. or even 6° C. of the process temperature, i.e. below the process temperature by not more than 10° C. or 6° C. Preferably, most of the multilayer plastic film other than the heat-sealable surface layer remains within 15° C. below the process temperature. Then, after the heat-sealable surface layer has been cooled below the heat-sealing temperature, the film is directed over a roller (e.g. a deflection, guide, support or transport roller) with the heat-sealable surface layer in contact with a surface of the roller. According to further preferred detail features of the inventive method, the roller itself may be cooled to a temperature below the heat-sealing temperature, and additional heat may be applied to the multilayer plastic film on the side opposite the heat-sealable surface layer while the heat-sealable surface layer is being cooled.

The above objects have further been achieved according to the invention in an apparatus for processing a multilayer plastic film as described above, comprising a roller, and a cooling arrangement positioned on the transport path of the multilayer film at a location upstream from the roller with respect to the film transport direction. The cooling arrangement is particularly a cold air blowing arrangement that blows cold air onto the surface of the heat-sealable surface layer of the multilayer film, in order to cool the heat-sealable layer to a temperature below the heat-sealing temperature, before the film reaches the roller. Furthermore, the apparatus may preferably comprise a heating arrangement located opposite the cooling arrangement, with the multilayer plastic film being transported along the transport path between the heating arrangement and the cooling arrangement. The cooling arrangement is preferably as close as possible to the inlet side of the deflection roller without directly contacting the deflection roller. For example, the end of the cooling arrangement closest to the deflection roller shall overlap the lateral diameter or radius of the deflection roller so that a vertical plane will pass through both the cooling arrangement and the deflection roller.

Thus, the general underlying feature of the invention is to rapidly cool the critical heat-sealable surface layer of the multilayer plastic film to an un-critical temperature, i.e. a temperature below the heat-sealing temperature, just before this plastic film reaches and actually contacts a deflection roller. This is achieved by providing a cooling arrangement for cooling the heat-sealable surface layer of the film at a location directly in front of the deflection roller. The cooling arrangement is especially embodied to achieve a highly effective rapid cooling of the heat-sealable surface layer.

In a preferred embodiment of the invention, the cooling arrangement comprises a set of air blowing nozzles that direct a high velocity flow of cooled air onto the heat-sealable surface layer of the plastic film. Thereby, the surface layer of the film is cooled to a sufficiently low temperature, so that the above discussed problems (e.g. adhesion of the film onto the roller) do not arise when the film runs onto a deflection roller, which itself may be cooled or uncooled.

It is further important according to the invention, however, that the overall temperature of the entire multilayer film is not cooled too much. In other words, it is important to cool essentially only the critical heat-sealable surface layer without significantly cooling the other layers of the multilayer plastic film. This is achieved by designing and constructing the cooling arrangement so as to provide a high heat transfer for the surface layer of the film in a rapid time and over the shortest possible distance. Thereby, the relatively poor thermal conductivity of the polymer materials of the layers of the plastic film will prevent any substantial cooling of the other film layers. In other words, the removal of heat from the surface layer of the film must be faster than the conduction transfer of heat through the several layers of the film. Furthermore, with such a high cooling rate being applied just before the contact with the roller, one can achieve a sufficient cooling of the heat-sealable layer before it runs onto the roller, without allowing the heat from the other layers to maintain or reheat the temperature of the heat-sealable layer to an unacceptably high level.

### BRIEF DESCRIPTION OF THE DRAWINGS

In order that the invention may be clearly understood, it will now be described in connection with example embodiments thereof, with reference to the accompanying drawings, wherein:

FIG. 1 is a schematic diagram showing a side view of a portion of a film processing machine or plant with a cooling arrangement according to the invention, for carrying out the method according to the invention;

FIG. 2 is a schematic diagram showing a portion of the apparatus according to FIG. 1, and additionally indicating several processing time points;

FIG. 3 is a schematic sectional diagram through a multilayer plastic film having several layers A to L;

FIG. 4 is a diagram showing a calculated temperature progression for each one of the layers A to L over time, with reference to the particular time points in FIG. 2, when using a highly cooled (very low temperature) deflection roller;

FIG. 5 is a diagram or graph with curves respectively showing the calculated temperature at a particular time point in the several layers A to L, also using a highly cooled deflection roller as in FIG. 4;

FIG. 6 is a schematic diagram corresponding to FIG. 4, but in connection with using a deflection roller that is not as greatly cooled (i.e. is at a higher temperature) in comparison to FIG. 4;

FIG. 7 is a diagram or graph corresponding to FIG. 5, but for the temperature and processing situation according to FIG. 6, with a deflection roller that is not as strongly cooled as in FIG. 5; and

FIG. 8 is a schematic diagram of a further embodiment of an apparatus according to the invention, generally according to FIG. 1, but additionally having a counter-heating arrangement.

### DETAILED DESCRIPTION OF PREFERRED EXAMPLE EMBODIMENTS AND OF THE BEST MODE OF THE INVENTION

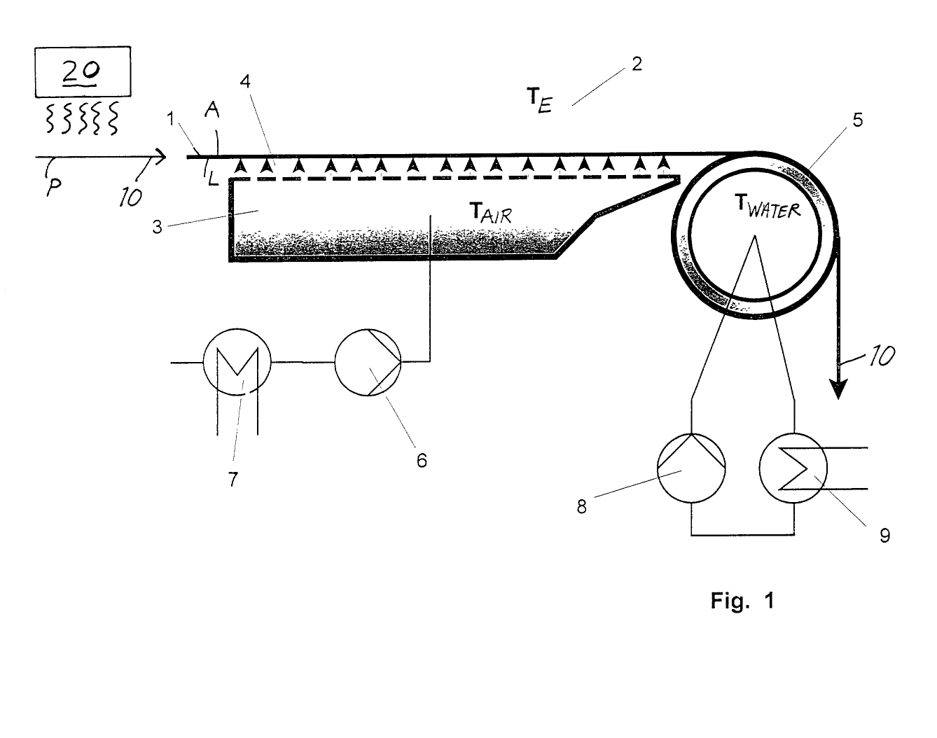

FIG. 1 schematically shows an apparatus according to the invention, representing a film processing apparatus or plant, with the additional provision of a cooling arrangement 3 according to the invention. A multilayer plastic film 1 having a heat-sealable outer layer L on the bottom or inner surface thereof is transported in a film transport direction 10 along a film transport path P from the left toward the right. The plastic film 1 is initially uniformly heated to a process temperature by an overall process heater 20, which may be a radiant heater or an air convection heater, for example. The film 1 is further transported in the direction 10 to pass over the cooling arrangement 3, which comprises a nozzle box or chamber with a plurality of air nozzles 4 arranged below the film 1 and oriented to blow cooled air onto the lower surface of the film 1, i.e. onto the heat-sealable outer layer L. The cooling arrangement further comprises an air cooler or chiller 7 and a blower 6, which respectively cool the air and then blow the cooled air into the nozzle chamber, to be distributed and blown through the air nozzles 4 onto the bottom of the film 1. The nozzles 4, the air cooler or chiller 7 and the blower 6 can have any conventionally known construction and arrangement of such devices.

A high total volume flow of cooled air is directed at a high velocity through the nozzles 4 onto the hot heat-sealable layer L of the film 1, which is initially at a temperature above the heat-sealing temperature of the layer L. Thereby, a high cooling rate, i.e. a high rate of heat transfer from the surface of the film layer L to the cooling air flow, is achieved due to the high air flow volume and velocity, the small spacing between the nozzles 4 and the film 1, and the sufficiently great temperature difference between the film temperature and the cooling air temperature achieved by the air cooler 7. Thereby, the heat-sealable layer L of the film 1 is rapidly cooled. The relatively poor thermal conductivity of the polymer materials of the film layers A to K making up the base film structure prevents a rapid conduction flow of heat from the other film layers A to K into the cooled film layer L.

By appropriately selecting the cooling air temperature, the air flow volume and velocity, and the total cooling time (based on the film transport velocity and the dimension of the cooling arrangement 3 extending in the film transport direction 10), it can be ensured that the heat-sealable layer L, upon exiting the downstream end of the cooling arrangement 3, has a sufficiently low temperature (e.g. below the heat-sealing temperature) so that it may come into contact with the adjacent deflection roller 5 without adhesion or bonding problems.

The deflection roller 5 itself is cooled by a water cooling circuit. Namely, a pump 8 circulates water that is cooled by a water cooler or chiller 9, in a cooling circuit through the deflection roller 5. The deflection roller 5 is cooled to a temperature that is sufficiently low to ensure that a heat-sealable layer L does not adhere onto the surface of the deflection roller 5. This cooling also prevents the deflection roller 5 from heating up over time during the film processing.

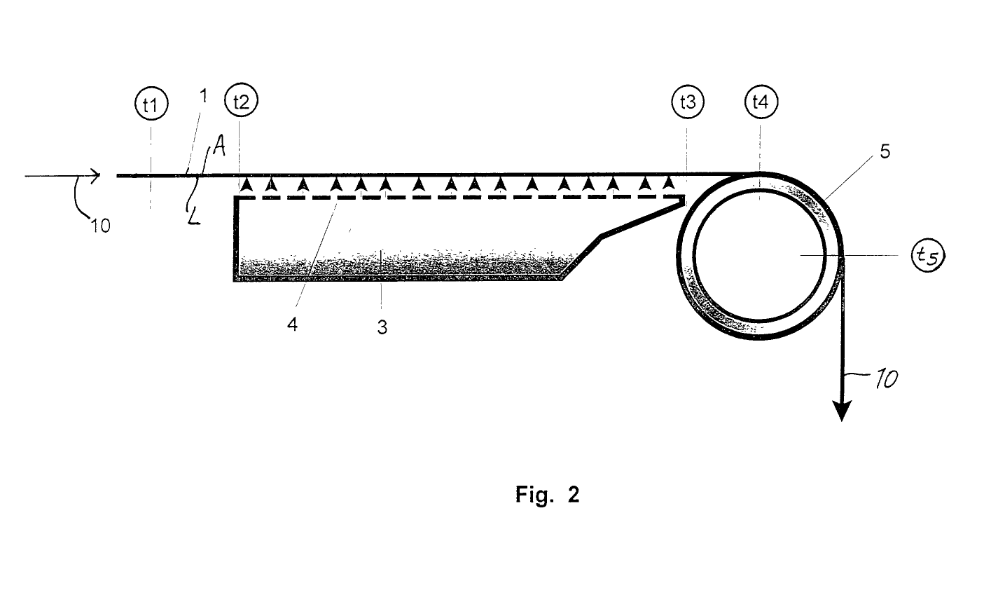

FIG. 2 generally corresponds to FIG. 1, but shows various locations or time points t1 to t5 during the film transport through the film processing apparatus. These time points t1 to t5 will be referenced in the subsequent drawings and the subsequent description. Time t1 represents the time when the film 1 is upstream of, and has not yet reached, the cooling arrangement 3. Time t2 is the time at which the film 1 (or any respective reference portion or reference point of the film 1) just reaches the upstream end of the cooling arrangement 3. Time t3 is the time at which the film 1 (i.e. the respective reference portion or reference point thereof) leaves the downstream end of the cooling arrangement 3. Time t4 is the time at which the film 1 (i.e. the reference portion or reference point thereof) begins to contact the roller 5. Time t5 is the time at which the film 1 (i.e. the reference portion or reference point thereof) ends the contact with the roller 5.

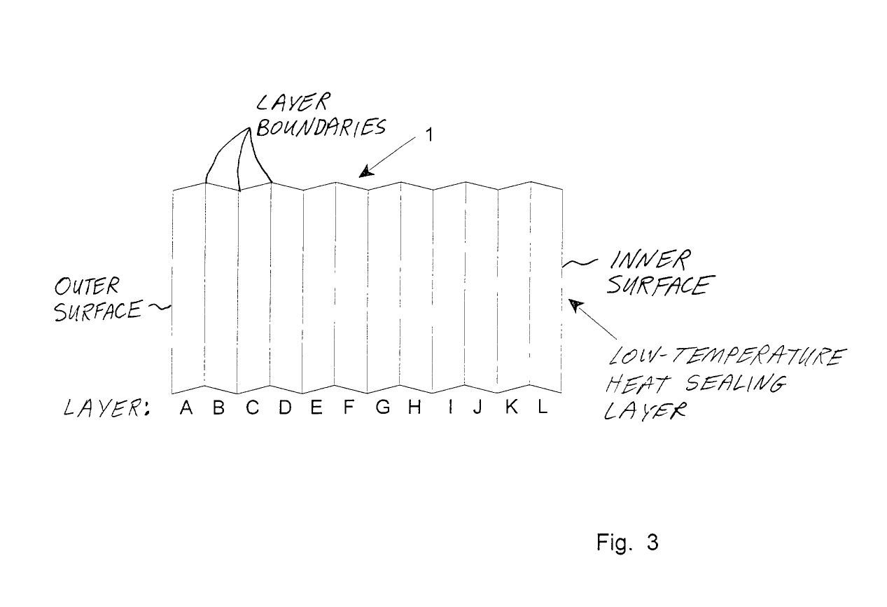

FIG. 3 schematically shows a cross-section through a multilayer plastic film 1, which comprises twelve successive layers A to L, each having equal thickness for the present example. This generalized twelve-layer film structure has been used as the basis for the thermal calculations of the temperatures prevailing in the plastic film, as discussed below. The outer or upper side surface of the film 1 is formed by the layer A, while the lower or inner surface is formed by the heat-sealable layer L. Thus, especially only the layer L is a heat-sealable layer, while the other layers A to K form a base film structure, for example providing the required tensile strength and other properties of the film. The base film structure generally is made up of at least one film layer. The successive layers A to L are theoretically separated from each other by layer boundaries, e.g. the layer boundary at the transition from layer A to layer B. The layers may each respectively be made of different polymer materials, or some or all of them may comprise the same polymer material or materials. Since the layers are fused to each other, the layer boundaries might not exist as distinct physical transitions in the actual film.

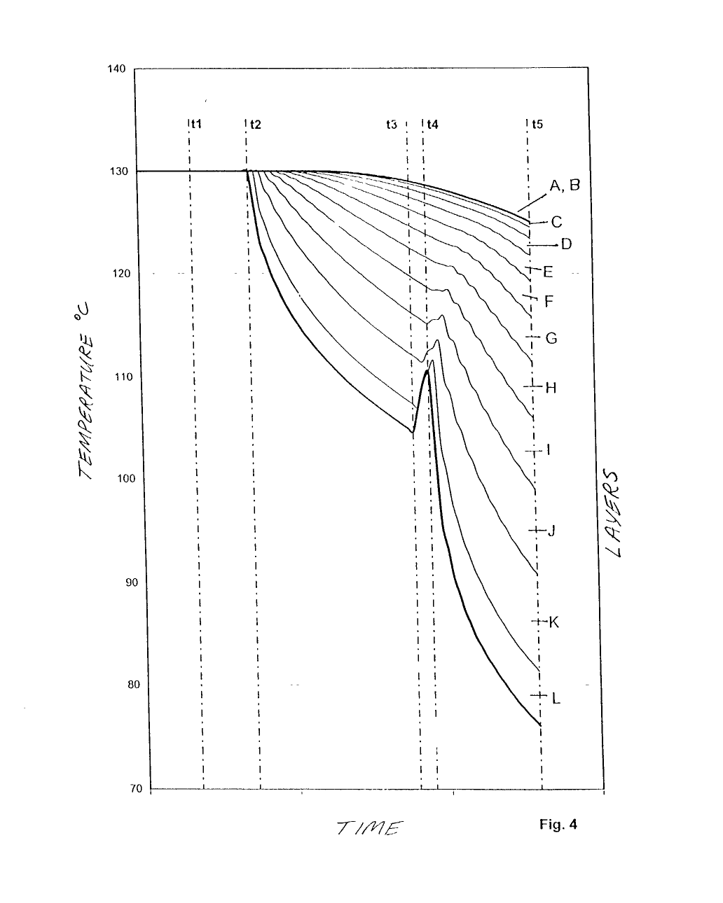

In the thermal calculations used as a basis for FIGS. 4 to 7, the temperature prevailing at a given time point at the respective layer boundaries was calculated using the Binder-Schmidt differential method. Then, after calculation of these temperatures at the layer boundaries, the approximate temperature progressions shown in FIGS. 4 to 7 were generated by connecting the data points of the temperatures prevailing at the respective layer boundaries at the respective time points.

FIG. 4 shows the calculated temperature progressions or temperature curves of the temperatures of the individual film layers A to L (or respective layer boundaries), relative to time. The individual time steps or time points t1 to t5 are shown on the time scale along the abscissa, while the temperature T is shown along the ordinate. The time points t1 to t5 are particularly those time points shown in FIG. 2.

At time t1, the temperature of all of the layers A to L of the film 1 is uniformly at the presumed process temperature of e.g. 130° C. This represents the situation before the film 1 enters the cooling arrangement 3. Namely, the film 1 is initially provided at the uniform process temperature of 130° C. There is essentially no variation of the temperature distribution through the thickness of the film 1. In other words, the film is completely, uniformly, and integrally heated throughout its thickness.

Then, at the time point t2, the film 1 is first transported into or over the cooling arrangement 3. During the interval from time t2 to time t3, the cooling air blown onto the bottom of the film 1 by the cooling arrangement 3 rapidly cools down the heat-sealable layer L. During this time interval, it can be seen that the layer L is rapidly and drastically cooled, while the upper surface layer A is only minimally cooled or not cooled at all. For example, at a time halfway through the cooling interval, i.e. a time halfway between t2 and t3, the upper layer A remains at the process temperature of 130° C., while the bottom surface of the heat-sealable lower layer L has been cooled to 110° C. The intermediate layers B to K take on intermediate temperatures, as the heat is sequentially conducted through the layers toward the cooled layer L.

At time t3, i.e. when the film 1 leaves the downstream end of the cooling arrangement 3, the heat-sealable bottom layer has been cooled to a temperature slightly below 105° C., while a slight cooling of the upper layer A, e.g. to a temperature of about 129° C. has taken place. A temperature distribution between the two external surface extreme temperatures is established in the intermediate layers.

In the time interval from t3 to t4, i.e. as the film is transported from the cooling arrangement 3 to the deflection roller 5, the overall average temperature of the overall film 1 has risen somewhat. Especially the temperature of the heat-sealable film L has risen by about 5° C. This temperature increase arises for two reasons. First, when traveling from the cooling arrangement 3 to the deflection roller 5, the film 1 passes for a short time and a short distance through the processing environment 2 within the processing apparatus, which is at a processing environment temperature T_{E}. Since this processing environment temperature T_{E} generally corresponds to the initial process temperature, e.g. 130° C., additional heat will be transferred to the cooled film 1 from the process environment 2, during the time interval from t3 to t4. Secondly, due to the nonuniform temperature distribution through the thickness of the film 1 at time t3, heat will flow from warmer layers to cooler layers in order to compensate or balance the temperature distribution. As a result, the heat-sealable layer L warms up while (at least most of) the other layers cool down.

The required cooling capacity of the cooling arrangement 3 must be selected and designed so that the temperature of the heat-sealable surface layer L, at the time t4 when it runs onto and contacts the deflection roller 5, is reduced to below its heat-sealing temperature, so that the layer L will not adhere onto the deflection roller 5. The cooling capacity of the cooling arrangement 3 is adjusted by means of the air flow volume and velocity, the air temperature, the length of the air nozzle blowing box or chamber in the film transport direction 10, the film transport speed, and the spacing distance between the nozzles 4 and the film 1.

The film 1 runs onto and contacts the deflection roller 5 at the time t4, and then remains in contact with the roller 5 until leaving the roller 5 at time t5. When the film 1 first contacts the roller 5 at time t4, the heat-sealable layer L is at a sufficiently low temperature, so that it will not adhere onto the surface of the deflection roller 5, as mentioned above. The overall film 1, and especially the heat-sealable layer L thereof, is strongly and drastically reduced in temperature in the time interval from t4 to t5, due to the direct contact with the cooled deflection roller 5.

In the present example of FIG. 4, the deflection roller is cooled to a rather low temperature of about 25° C. The direct contact of the film 1 onto the very cool roller 5 achieves a high, rapid rate of cooling, as can be seen by the sharp downward slope of the temperature curve of the bottom surface of the layer L in the time interval from t4 to t5 in FIG. 4. It can be seen that this rate of cooling is faster than the rate of cooling provided by the cooling arrangement 3 in the time interval from t2 to t3. As a result, not only the heat-sealable layer L, but also the overall film 1 (i.e. the other layers thereof) have also undergone a noticeable cooling in the time interval from t4 to t5. According to the invention, it has been determined that such a combination of processing conditions is not optimal, but instead that a somewhat warmer (not so drastically cooled) deflection roller 5 achieves a more advantageous temperature distribution in the film 1, as will be discussed below.

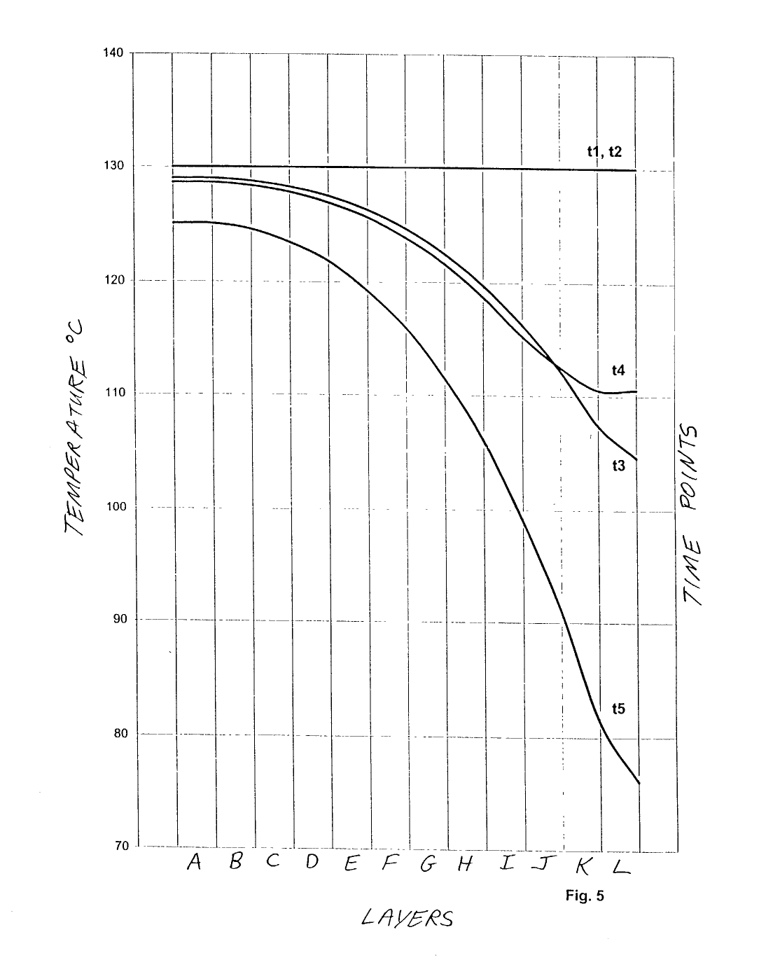

For the same example as discussed above in connection with FIG. 4, e.g. a process temperature of 130° C. and a deflection roller temperature of 25° C., FIG. 5 shows the calculated temperature curve at each time point, through the various layers A to L of the film 1. In other words, each temperature curve in FIG. 5 shows the temperatures at a given time point, as the temperatures vary through the several layers. The individual layers A to L are indicated along the abscissa, while the temperature T is indicated along the ordinate. Thus, while FIG. 4 shows the temperature progression in each layer over time, FIG. 5 shows the temperature progression at each time as a function of the layer location.

A shown in FIG. 5, at time points t1 and t2, the entire film 1 is completely and uniformly heated to the process temperature of 130° C., throughout all of the layers A to L. At time point t3 upon leaving the cooling arrangement 3, the temperature on the directly cooled side, i.e. the layer L, is sharply reduced, while the opposite side. e.g. layer A, is still nearly at the initial process temperature. Then, at time point t4 in the transition from the cooling arrangement 3 to the deflection roller 5, the temperature becomes somewhat more uniform throughout the film 1. Especially, the temperature in the layers K and L rises somewhat due to the surrounding environmental temperature T_{E} of 130° C., while the temperature of the other layers drops somewhat. Then in the transition or interval from time point t4 to time point t5, through the contact with the cooled deflection roller 5 at 25° C., the temperature of the film 1 drops to below 80° C. in the surface film L, while the temperature of the opposite outer side layer A remains at a relatively high temperature of about 126° C.

In order to optimize the process, in addition to the correct design of the cooling arrangement 3, it is important to achieve the smallest possible spacing distance between the cooling arrangement 3 and the deflection roller 5. The shorter this distance, the smaller will be the temperature increase of the film 1 in this transition area from the time point t3 to the time point t4. Thus, according to the invention, this spacing distance and this time interval should be made as small as possible, namely that the downstream edge of the cooling arrangement 3 is directly adjacent to the deflection roller 5, without contacting the deflection roller 5. Preferably, there should at least be a horizontal overlap between the horizontal extension of the cooling arrangement 3 and the horizontal diameter of the deflection roller 5, namely so that a vertical plane at the downstream edge of the cooling arrangement 3 will pass through the deflection roller 5.

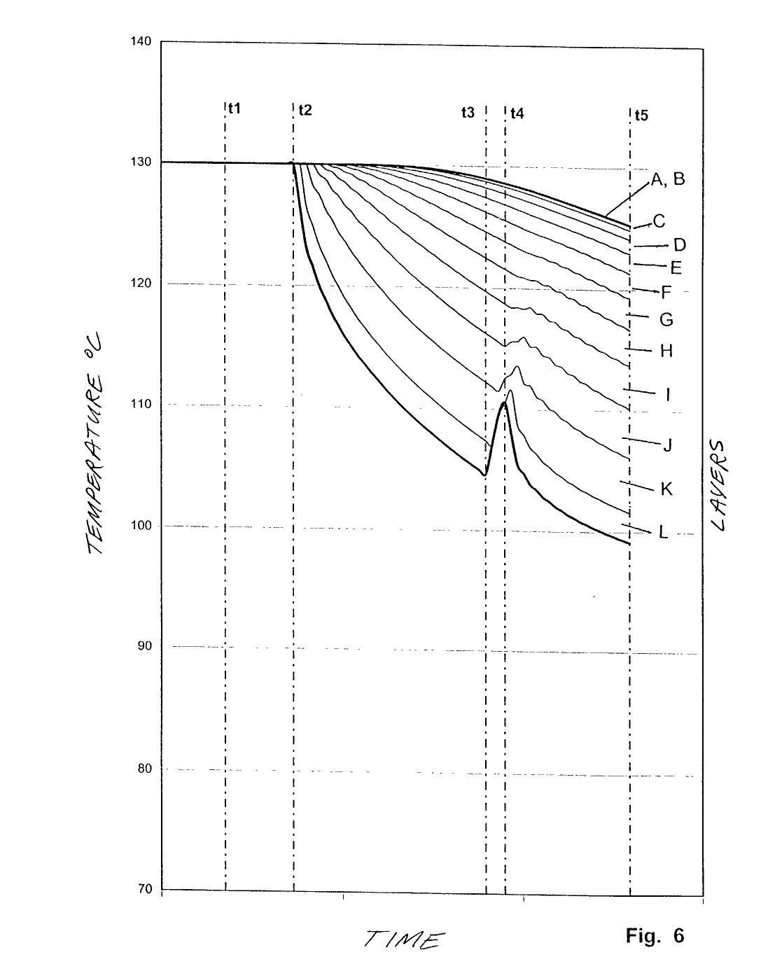

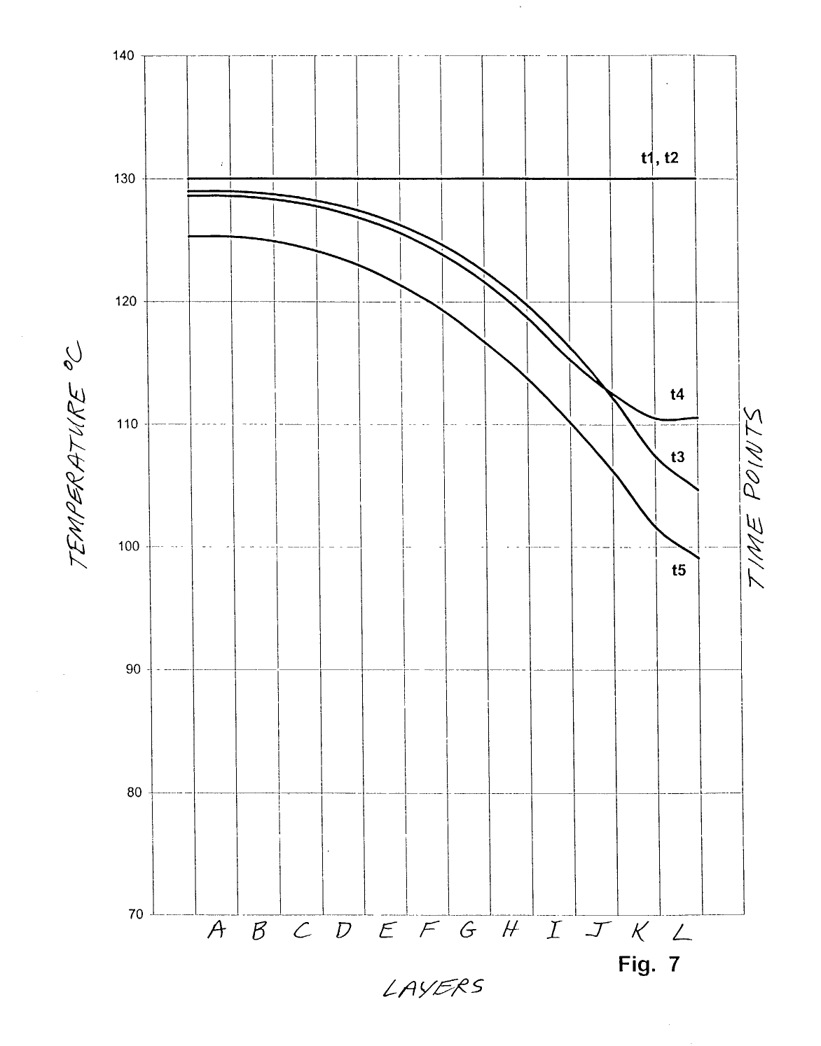

Also it has been determined according to the invention, as mentioned above, that a drastic cooling of the deflection roller 5, for example down to 25° C., is not necessary and in fact is disadvantageous, because it strongly influences the temperature level of the entire film 1. Instead, it has been determined that the deflection roller 5 may be cooled to a roller temperature that is only slightly, e.g. 5 to 30° C. and preferably only 5 to 20° C. or especially preferably less than 10° C. lower than the heat-sealing temperature of the layer L, in order to effectively avoid an adhesion of the film 1 onto the surface of the deflection roller 5. The temperature progression of the film 1 in such a process with a deflection roller 5 at a roller temperature of, e.g., about 90° C. is shown in FIGS. 6 and 7.

FIGS. 6 and 7 correspond to FIGS. 4 and 5, except that the deflection roller 5 is now at a temperature of 90° C. rather than 25° C. As can be seen in FIGS. 6 and 7, the inner heat-sealable surface layer L of the film 1 is still adequately cooled to a temperature below its heat-sealing temperature, whereas the overall temperature throughout the several layers of the film 1 remains more uniform and higher than in the prior example. Also, as can be seen in FIG. 6, the cooling rate provided by the contact with the cooled roller 5 in the time interval t4 to t5 is no greater than, or preferably less than, the cooling rate provided by the cooling arrangement 3 in the time interval t2 to t3. Preferably also, a greater extent (i.e. degree range) of cooling of the heat-sealable layer should be provided by the cooling arrangement 3 rather than by the cooled deflection roller 5.

In general, a deflection roller temperature of e.g. 80 to 100° C. and especially about 90° C. is adequate for most films having a typical heat-sealable layer with a heat-sealing temperature of 100 to 140° C., and a roller temperature of 60 to 75° C. is suitable for heat-sealing layers with a heat-sealing temperature of 70 to 80° C.

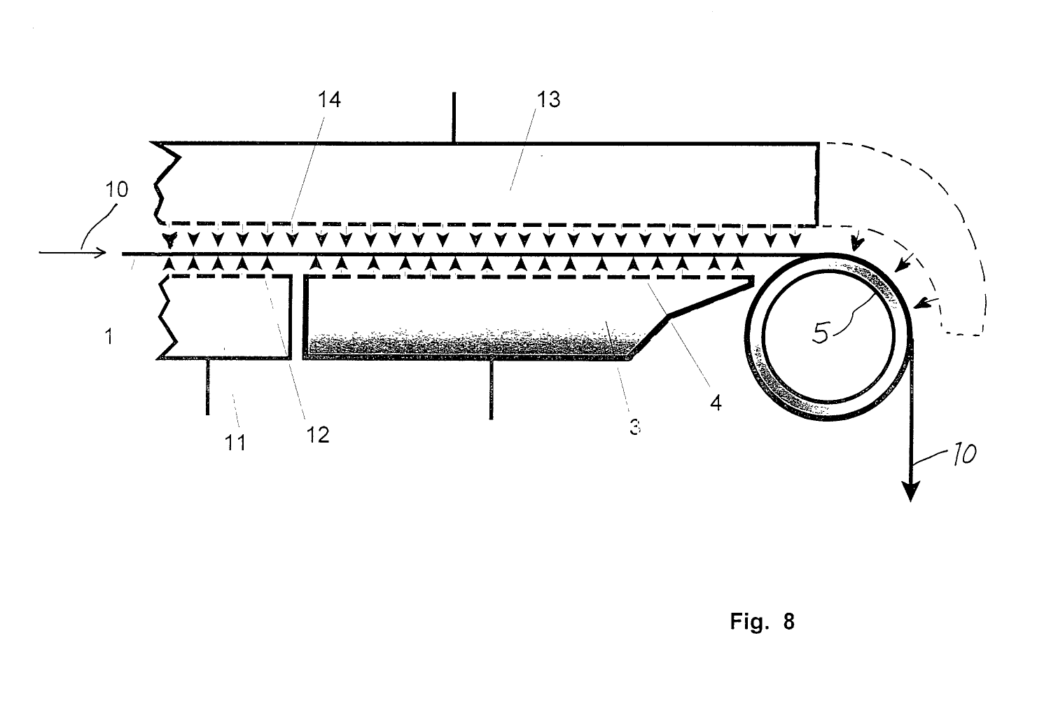

FIG. 8 shows a further embodiment of the invention which helps to ensure that the remainder of the film 1 is not significantly cooled while the heat-sealable layer L of the film 1 is being cooled to below its heat-sealing temperature. In this embodiment, the apparatus further comprises a counter-heating arrangement 30 with hot air blowing nozzles 14, which blow hot air onto the upper surface of the outer layer A of the film 1 opposite the inner surface of the layer L that is cooled by the cooling arrangement 3. Another heating arrangement 11 with hot air blowing nozzles 12 can be arranged next to the cooling arrangement 3 on the upstream side thereof, in order to blow hot air onto the inner surface of the film 1 so as to maintain the film 1 uniformly at the process temperature up to the point at which the film 1 reaches the cooling arrangement 3.

With such an apparatus embodiment, the entire film 1 can be uniformly heated to and maintained at the process temperature until the point of reaching the cooling arrangement 3. Then, the cooling arrangement 3 effectively cools especially only the bottom or inner layer L thereof, while the heating arrangement 13 provides heat to the outer surface of the film 1 to help prevent a reduction of the average temperature of the film 1. The heating arrangement 13 can also be further extended around the deflection roller 5 as shown by dashed lines.

With the inventive method and apparatus, the heat-sealable surface layer can be cooled by the cooling arrangement 3 just upstream of the roller 5, e.g. to a temperature that is below the process temperature by at least 20° C., while the opposite surface of the film remains close to the process temperature, e.g. below the process temperature by not more than 3° C. Throughout the entire process along the cooling arrangement and the roller, the opposite surface of the film remains at a temperature of no more than 6° C. below the process temperature, for example. During the transition from the cooling arrangement to the roller, the temperature of the heat-sealable layer rises by no more than 7° C. for example, while the temperature of the opposite surface of the film drops by no more than 2° C. for example.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method of processing a multilayer plastic film including a base film structure and, on said base film structure, a heat-sealable surface layer that becomes heat-bondable at and above a heat-sealing temperature, wherein said method comprises the steps:
a) heating said film to a process temperature such that said heat-sealable surface layer is at or above said heat-sealing temperature;
b) after said step a), cooling said heat-sealable surface layer to below said heat-sealing temperature, while maintaining at least most of said base film structure above said heat-sealing temperature; and
c) after said step b), contacting said heat-sealable surface layer onto a roller while transporting said film on said roller.

2. The method according to claim 1, wherein most of said base film structure remains at a temperature closer to said process temperature than to said heat-sealing temperature in said step b).

3. The method according to claim 1, wherein said cooling of said step b) is carried out with a cooling heat transfer rate greater than a heat conduction rate through said base film structure.

4. The method according to claim 1, wherein, at the completion of said cooling of said step b), said heat-sealable surface layer is at a temperature that is below said process temperature by at least 20° C., and at least a surface of said base film structure opposite said heat-sealable surface layer is at a temperature that is below said process temperature by not more than 3° C.

5. The method according to claim 4, wherein said surface of said base film structure opposite said heat-sealable surface layer is never below said process temperature by more than 6° C. throughout said steps b) and c).

6. The method according to claim 1, further comprising carrying out said steps b) and c) in an ambient processing environment maintained at said process temperature.

7. The method according to claim 1, further comprising, between said steps b) and c), allowing a partial temperature normalization in said film, whereby a temperature of said heat-sealable surface layer increases and a temperature of a surface of said base film structure opposite said heat-sealable surface layer decreases.

8. The method according to claim 7, comprising minimizing a duration of said partial temperature normalization so that said temperature of said heat-sealable surface layer increases by no more than 7° C., and said temperature of said surface of said base film structure decreases by no more than 2° C.

9. The method according to claim 7, wherein said temperature of said heat-sealable surface layer remains below said heat-sealing temperature at an end of said partial temperature normalization.

10. The method according to claim 1, further comprising cooling said roller to a temperature below said heat-sealing temperature.

11. The method according to claim 10, wherein said temperature of said roller is below said heat-sealing temperature by no more than 30° C.

12. The method according to claim 10, wherein said temperature of said roller is selected so that a cooling rate of said heat-sealable surface layer during said cooling of said step b) is greater than a cooling rate of said heat-sealable surface layer during contact thereof with said roller.

13. The method according to claim 1, wherein an average temperature of said film at an end of said cooling of said step b) is above said heat-sealing temperature.

14. The method according to claim 1, wherein said heat-sealing temperature is below said process temperature.

15. The method according to claim 1, wherein said step b) comprises blowing cool air directly onto an exposed surface of said heat-sealable surface layer.

16. The method according to claim 1, further comprising applying heat to a surface of said base film structure opposite said heat-sealable layer during said cooling of said heat-sealable layer in said step b).

17. The method according to claim 16, further comprising continuing said applying of heat after said step b) and during said step c).

18. An apparatus for processing a multilayer plastic film including a base film structure and, on the base film structure, a heat-sealable surface layer that becomes heat-bondable at and above a heat-sealing temperature, wherein said apparatus comprises:
heating means for heating the film to a process temperature such that the heat-sealable surface layer is at or above the heat-sealing temperature;
cooling means for cooling the heat-sealable surface layer to below the heat-sealing temperature, while maintaining at least most of the base film structure above the heat-sealing temperature; and
roller means for contacting the heat-sealable surface layer onto a roller while transporting the film over said roller, at a location downstream of said cooling means on a film transport path along which the plastic film is transported.

19. An apparatus for processing a multilayer plastic film including a base film structure and, on the base film structure, a heat-sealable surface layer that is heat bondable at and above a heat-sealing temperature, wherein said apparatus comprises:
a process heater adapted to heat the plastic film to a process temperature above the heat-sealing temperature;
a roller selected from the group consisting of a guide roller, a deflection roller, a support roller, and a drive roller, wherein a film transport path, along which the plastic film is transported through said apparatus, passes tangent to said roller so that the heat-sealable surface layer of the plastic film contacts said roller as the film is transported through said apparatus; and
an air-blowing cooling arrangement located upstream of said roller along said film transport path, wherein said cooling arrangement is configured and adapted to blow cool air onto the heat-sealable surface layer of the plastic film so as to cool the heat-sealable surface layer to below the heat-sealing temperature.

20. The apparatus according to claim 19, wherein said cooling arrangement comprises plural air blowing nozzles directed to blow cool air onto the heat-sealable surface layer of the plastic film on the film transport path.

21. The apparatus according to claim 20, wherein said cooling arrangement further comprises an air cooler and a blower connected in series to an air plenum chamber that communicates to said air blowing nozzles.

22. The apparatus according to claim 19, further comprising a counter-heater arranged opposite said cooling arrangement with said film transport path passing therebetween, and adapted to supply heat to a surface of the plastic film opposite the heat-sealable surface layer.

23. The apparatus according to claim 22, wherein said counter-heater extends along said cooling arrangement and at least partially around said roller with said film transport path passing therebetween.

24. The apparatus according to claim 19, wherein said cooling arrangement extends toward said roller along said film transport path to a downstream end of said cooling arrangement that is located so that a vertical plane extending through said downstream end of said cooling arrangement will also extend through said roller.
